(19) United States
(12) Patent Application Publication
(10) Pub. No.: US 2026/0238039 A1
(43) Pub. Date: Aug. 13, 2026

(54) METHOD AND APPARATUS FOR CAPACITIVE WIRELESS POWER TRANSMISSION

(71) Applicant: REMOTE ENERGY LTD., Petah Tikva (IL)

(72) Inventors: Alexander AXELROD, Petah Tikva (IL); Serge SVEDCENKO, Nesher (IL)

(21) Appl. No.: 19/157,554

(22) PCT Filed: Feb. 26, 2024
(86) PCT No.: PCT/IL2024/050219

§ 371 Date: Aug. 18, 2025

Related U.S. Application Data
(60) Provisional application No. 63/448,295, filed on Feb. 26, 2023.

(51) Int. Cl. H02J 50/05; H01Q 1/48; H01Q 9/04; H02J 50/50

(52) U.S. Cl. CPC H02J 50/05; H01Q 1/48; H01Q 9/0435; H02J 50/50

(57) ABSTRACT

A system for capacitive wireless power transmission comprises (a) an adjustable RF power source configured for varying an RF frequency thereof; (b) a power transmission channel configured for capacitive wireless power transmission; (c) a feedback communication channel configured for providing a feedback signal for matching up a system impedance to an instant value of capacitance between TX and RX electrodes; (d) a processor configured for varying the RF frequency of the RF power source. Each of the TX and RX portions of power channel further comprises a ground plane disposed behind the TX and RX electrodes, respectively. The processor is configured for selecting an RF frequency to be generated by the power source corresponding to minimal transmission losses by means of compensation of capacitance between TX and RX electrodes by a sum of inductive reactances formed between the electrodes and the ground planes of the TX and RX portions.

### FIELD OF THE INVENTION

The present invention relates to wireless power transmission systems, and more particularly, to capacitive wireless power transmission enabling efficient operation in proximity with massive metallic objects and enhanced power density.

### BACKGROUND OF THE INVENTION

The capacitive wireless power transmission employs capacitance between TX and RX electrodes as a path for RF energy flow. The inter-electrodes capacitance is very small, typically in order of several tens of pF, and, in the radio frequency (RF) band, can be presented as a series high capacitive impedance on the way of the RF energy flow. At the system operational frequency, this impedance is traditionally compensated by passive coupling networks added, preferably, on both sides of the air gap. The main purpose of the coupling device on the TX side of the system is to transform relatively low output impedance of the RF power source into high inductive impedance seen from the TX electrode back to the RF energy source. Similarly, the coupling device at the RX side has to transform back the high inductive impedance near the RX electrode to relatively low input impedance of the RF rectifier. The desire to reduce the capacitive impedance of the air gap between TX and RX electrodes implies the CWPT system operation at relatively high radio frequencies. In addition, high inductive reactance at the sides of TX and RX electrodes, being typically in order not greater than few kΩ, can be achieved only if inductors feature high quality factor (the Q-factor). The RF coils losses play a critical role because the coils contribution to the overall power losses to the entire system transmission efficiency can be evaluated as being within the range of 82% and 96%. Therefore, there is a long-left and unmet need for providing an alternative approach to compensation of the air gap capacitive reactance.

It is hence one object of the invention to disclose a system for capacitive wireless power transmission comprises: (a) an adjustable RF power source configured for varying an RF frequency thereof; said adjustable RF power source having an RF power amplifier; (b) a power transmission channel configured for capacitive wireless power transmission further comprising transmitting (TX) and receiving (RX) portions; said TX and RX portions comprise transmitting and receiving metallic patch electrodes, respectively, facing each other via an air gap; (c) a feedback communication channel configured for providing a feedback signal for matching up an output impedance of the RF power source to impedance instantly presented by the power transmission channel; said feedback communication channel further comprising transmitting and receiving portions FTX and FRX, respectively; a processor configured for varying said RF frequency of said power transmission channel.

The main technical feature of the invention is to provide each of said TX and RX portions further comprising TX and RX ground planes disposed behind said TX and RX electrodes, respectively. The processor is configured for selecting an RF frequency to be generated by said power source corresponding to minimal power transmission losses by means of compensation of a capacitive reactance formed between said TX and RX electrodes by means of a sum of inductive reactance formed by said TX electrode and TX ground plane, and the reactance formed by said RX electrode and the RX ground plane.

Another object of the invention is to disclose the patch electrode selected from the group consisting of a rectangular patch electrode, a triangular patch electrode, a hexagonal patch electrode, a circular patch electrode, an oval patch electrode, an annular patch electrode, and any combination thereof.

A further object of the invention is to disclose the patch TX and RX electrodes having at least one slot, or slit or short to the ground plane.

A further object of the invention is to disclose the feedback communication channel selected from the group consisting of an RF communication channel, an acoustic communication channel, an optical communication channel, and any combination thereof.

A further object of the invention is to disclose a carrier of the said feedback communication channel which is sufficiently greater than said RF frequency of said RF power source such that the carrier frequency may be modulated by the said frequency of the said power channel.

A further object of the invention is to disclose the carrier frequency of said feedback communication channel modulated in said FTX portion of said communication channel by a signal coherent with an RF power intensity signal received in said RX portion; in said FRX portion of said communication channel, said RF power intensity is demodulated;

A further object of the invention is to disclose a demodulated signal is alternatively fed to said processor which controls said RF power source, or to an input port of said RF power amplifier such that said power transmission channel and said communication channel conjointly operate in a self-oscillatory closed loop mode.

A further object of the invention is to disclose the power amplifier having an input port; said input port further comprises a frequency selective filter configured for preventing system oscillations at frequencies belonging to a filter stop frequency band; said stop band frequency is adjustable either by said processor or manually.

A further object of the invention is to disclose the TX and RX patch electrodes having two or more feed points thereof each connected by coaxial cables to output ports of two or more coherent RF power sources and RX rectifiers, respectively. Positions of said feed points correspond minimal return losses of said RF power sources and maximal decoupling of said RF power sources.

A further object of the invention is to disclose the TX and RX patch electrodes which are disc- or ring-like shaped, said disc- or ring-like shaped patch TX and RX electrodes are excited by first and second coordinated-phase coherent power sources. Output powers of said first and second sources each, excite the TM11 mode of cylindrical cavities formed between each electrode and the ground plane in proximity to said disc- or ring-like shaped patch TX and RX electrodes; and said feed points connected to said first and second RF sources are located at a relative coordinated azimuthal orientation.

A further object of the invention is to disclose the TX and RX patch electrodes excited by two or more pairs of said coherent RF power sources. An operation frequency of said power sources within each pair operate does not coincide with operation frequencies of other pairs.

A further object of the invention is to disclose the TX and RX patch electrodes formed by a plurality of concentrically arranged annular members. Each annular member of said TX portion is fed by a number of coherent RF sources exciting orthogonal modes of a near electromagnetic field. Each annular member of said TX portion is impedance-matched said operation frequency thereof.

A further object of the invention is to disclose the operation frequency selected by maximizing said RF power transmission alternatively by: (a) switching between a plurality of said RF power sources each connected to said annular members of said TX portion in an individual manner, until the maximum power transmission is achieved; and (b) concurrently tuning single RF source to the operational frequency corresponding to a dedicated annular member and connecting its power output port to the said annular member, in a way maximizing the system RF power transmission.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of a system for capacitive wireless power transmission in an open-loop operation mode;

FIG. 2 is a schematic diagram of a system for capacitive wireless power transmission in a closed-loop self-oscillating operation mode;

FIG. 3 is an equivalent electrical diagram of a power transmission channel;

FIG. 4 is a graph of dependence of input impedance on frequency for a typical rectangular or circular patch antenna;

FIG. 5 is an equivalent electrical diagram of an open cylindrical resonator in the point of the parallel resonance;

FIG. 6 is a graph of dependence of equivalent transfer impedance on frequency of a tandem connection of three cavities comprising a power transmission channel;

FIG. 7 is a diagram illustrating geometry of a typical micro-strip disc patch antenna;

FIG. 8 is a diagram of a circular patch operating at TM11 excited by two feeds;

FIG. 9 is a diagram illustrating distribution of magnetic field for TM11 mode within the volume between the patch and the ground plane;

FIG. 10 is a diagram of a circular disc patch electrode with two-probe feeds with proper angular locations; and

FIG. 11 is a diagram of a patch electrode comprising a number of annular members.

### DETAILED DESCRIPTION OF THE INVENTION

The following description is provided, so as to enable any person skilled in the art to make use of said invention and sets forth the best modes contemplated by the inventor of carrying out this invention. Various modifications, however, are adapted to remain apparent to those skilled in the art, since the generic principles of the present invention have been defined specifically to provide a system for capacitive wireless power transmission.

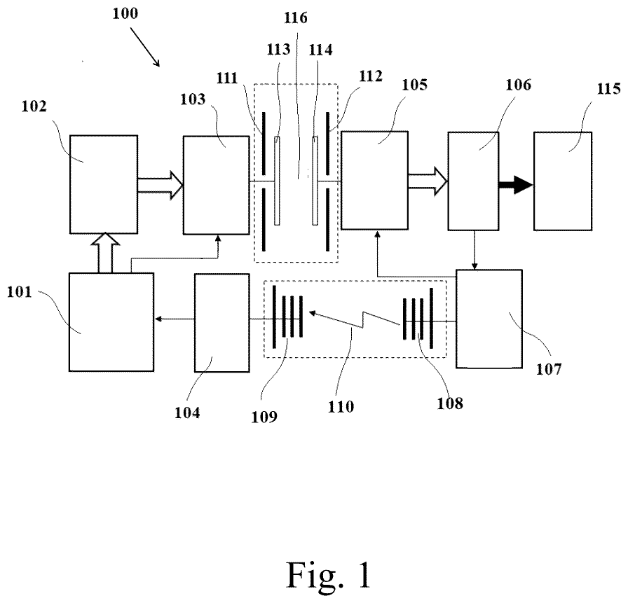

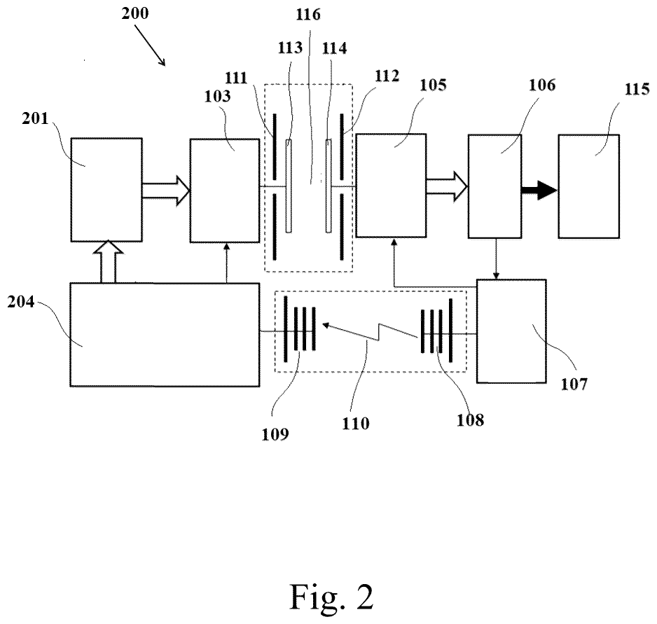

Reference is now made to FIGS. 1 and 2 presenting two alternative embodiments 100 and 200 of the present invention. In both embodiments, resonant patch electrodes 113 and 114 are located above ground planes 111 and 112 on both sides of air gap 116. Patch electrodes 113 and 114 are fed by coaxial cables (not shown). Patch electrodes 113 and 114 constitute a pair of traditional identical patch antennas faced each other with mutually overlapping near fields. Contrary to the prior art technical solutions utilizing far-field radiation, in the present invention, patches electrodes 113 and 114 above ground planes 111 and 112, respectively, as electric field TX and RX electrodes in the CWPT system providing near-field power transmission.

Since the far-field radiation implies non-productive energy losses, patches electrodes 113 and 114 are intentionally operated in a non-radiation regime aside of their resonance frequencies. Although the patches electrodes 113 and 114 are not exactly in the resonance frequency, they are not operated in quasi-static regime like in traditional CWPT systems. The cavities formed between the patches and their ground planes support the cavity oscillation modes with significant phase variations in the apertures between patches electrodes 113 and 114 and ground planes 111 and 112. The operational frequency is intentionally selected in a way that patches electrodes 113 and 114 represent storages of inductive reactive power which is sufficient for compensation of capacitive power stored in the air gap 116 between the patches electrodes 113 and 114.

The system comprises two channels:
a) A power transmission channel configured for capacitive wireless power transmission; the RF power is transmitted from the left (TX) side to the right (RX) side, and
b) A feedback communication channel configured for providing a feedback signal for matching up a system transfer impedance to a instant value of variable capacitance between TX and RX electrodes 113 and 114 presented by the air gap 116.

The feedback communication channel is usable for providing a feedback in two operation modes. Specifically, in open RF signal loop, as shown in FIG. 1, when the operational frequency is defined by the oscillator 102. In this case, the feedback is employed for adaptive adjustment of the oscillation frequency of the oscillator 102 and of impedance matching device 103 located on the TX side, based on the feedback information on the DC power delivered to the load 115 located on the RX side.

In a closed-loop or self-oscillatory regime, illustrated in FIG. 2, the loop is formed by the power transmission channel and feedback communication channel. The RF power generated by RF power amplifier 201 is successively transferred via the first coaxial cable (not shown) with the cable's external conductor electrically bonded to the ground plane 111, patch electrode 113 in the TX portion and then via patch electrode 114 and the second coaxial cable (not shown) with the cable's external conductor electrically bonded to the ground plane 112 in the RX portion. A feedback sinusoidal signal coherent with the forward RF power waveform returns via the feedback communication channel. The real-time feedback signal modulates the higher-frequency carrier, for example, in RF transmitter 107 located on the FRX side and is demodulated by the FRF receiver 204 located on the TX side of the system. Numerals 108 and 109 refers to FTX and FRX antennas, respectfully, divided by air gap 110. The demodulated sinusoidal signal in FRF receiver 204 is then fed to the input port of the RF power amplifier 201. This closes the self-oscillatory RF loop.

In both configurations the RF receiver, 104 in FIGS. 1 and 204 in FIG. 2, demodulates the information on the level of rectified power fed into the load and generates the control signal having the goal to adjust the impedance matching network 103 in FIG. 1 and FIG. 2 in a way enhancing the level of the rectified DC power. Similarly, the microprocessor incorporated in the RF transmitting unit 107 in FIG. 1 generates control signal regulating the impedance matching network 105. This operation closes the second feedback loop of the system.

RF transceivers 107 and receivers 104/204 in the feedback communication channels of the alternative embodiments of the present invention may be replaced by their counterparts operating with acoustic (ultrasound) waves or by the pair of optical radiator and receiver (e.g. photoelectric diodes).

In all known from the prior art wireless power transmission system designs employing either capacitive and inductive coupling between TX and RX electrodes, nearby metallic structure prevent the system's efficient operation. TX and RX magnetic coils of inductive systems induce undesirable eddy currents in co-located metallic parts, and this causes heavy power losses. Similar lossy effects exist in slightly and heavily conductive soil which may surround the electrodes. In particular, these proximity effects are undesirable in CWPT systems, since any parasitic capacitance diverts some amount of RF current from the TX electrode to undesirable directions.

The main idea of the proposed design approach is to employ such RX and/or TX portions which embed the massive metallic structure, e.g. ground plane, into their design. From the prior art we know, that there are two types of RF antennas which employ ground planes: slot and patch antennas. Unfortunately, slot antennas need back cavity with sufficiently large profile, and this makes them less attractive than the shallow patch antenna option. Nevertheless, we cannot deny completely the slot design alternative. Without scarifying the generality, we proceed with the following discussion for the design option of the patch-above-the-ground electrodes.

The term “patch” electrode encompasses a wide range of shapes. Electrodes may be shaped as either circular, rectangular, triangular, hexagonal, ring or of any other size known from the prior art. Slots, slits and shorts between the patch and the ground plane may be added, as required for selective mode control.

Traditionally patch antennas are operated at one of their resonance frequencies, at which active part of its input impedance reaches its maximum value, the reactive impedance is practically at its zero point, and the antenna is used for signal transmissions to the far field. As shall be shown shortly, neither of these traditional rules are applicable to design of patch electrodes used in the wireless CWPT (e.g. EV battery charging) application. Instead, the proposed TX and RX patch electrodes should be operated with some relatively small but principally existing offset from their resonance frequencies and are set in near-field operational conditions. Naturally, radiation losses contributing to high value of the active part of input impedance should be eliminated. Instead, the patch antenna is employed exclusively as inductive reactive element compensating high-impedance capacitive contribution of the air gap between TX and RX patch electrodes. Under such conditions, the active part of its input impedance should be mainly due to the active power transmission from the TX side to the RX side and due to metallic losses.

In order to operate the system in the proximity to the patch resonance frequency, the patch linear dimensions should be selected sufficiently close to half wavelength at the operational frequency. This circumstance imposes limitations on the patch design, and the patch physical dimensions should be sufficiently large in order to operate at sufficiently low operational frequency. The demand for the design compactness leads to:
a) Operation at sufficiently small wavelength (i.e. sufficiently large frequency);
b) Selection of dielectric medium between the patch and the ground plane with sufficiently large dielectric constant Er;
c) Use of patch electrodes with special shapes, slots, slits and shorts to the ground plane.

The latter design consideration should be elaborated. Either patch electrode in the CWPT application or patch antenna, are in essence devices operating on the resonance mode of their slot aperture formed between the patch periphery and the ground plane. This fact led to appearance of a diversity of relatively compact patch shapes in the prior art. The feature common for all these compact patch antenna designs was relatively large patch perimeter, while the patch area was kept as small as possible. This feature was achieved by introduction of cuts in the patch geometry. This design measure proved to be effective and allowed impressive shrinking of the patch size. Nevertheless, the option of operating at sufficiently high frequency also cannot be denied, since this trend is in line with the desire to decrease the capacitive reactance of the air gap between TX and RX electrodes of the CWPT system. The demand for small-size TX-RX electrodes stems from the need to deploy multiple-modular CWPT system in automotive platforms with limited real estate. This means that several patches-electrodes should be co-located both on TX and RX sides. The operation at relatively high frequency, although employed in the CWPT applications, may lead to increased ohmic losses at the power generation and rectification stages, and consequently, to degradation of the overall system power transmission efficiency. Therefore, reasonable compromise between the antenna size and the operational frequency should be found in practical system designs. As a result, the proposed in this patent application patch electrodes should operate preferably at the patch lowest resonance frequency to realize the most compact antenna featuring optimally large power transmission efficiency.

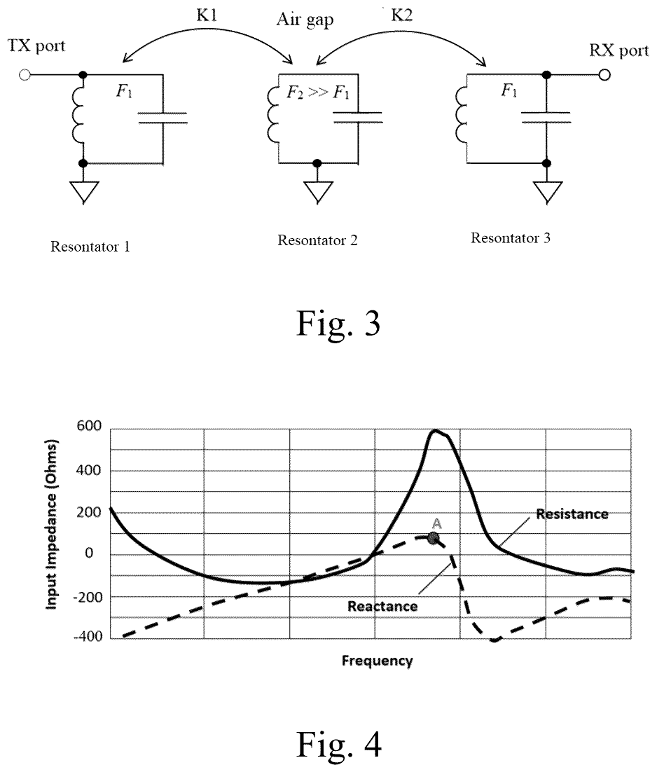

The system section responsible for the power transmission via the air gap may be viewed as a tandem connection of two rectangular patch antennas on both sides of a single rectangular open resonator (the air gap). Each patch antenna and the air gap area are actually open cavity resonators. Reference is now made FIG. 3 presenting an equivalent diagram of a tandem configuration of three energetically coupled open resonator. Specifically, coupling coefficients K1 and K2 between the resonators may be derived by considering electrical currents induced on the common metallic walls (the metallic patches) separating the adjacent resonators. Surface currents induced by each resonator on the common metallic wall flow along the opposite side of the metallic patch, overlap with similar currents of an adjacent resonator. Similarly, electromagnetic fields developed near edges of each one of three resonators overlap, and also contribute to the mutual coupling.

The equivalent diagram in FIG. 3 enables qualitative analysis of the entire RF section, starting with the behavior of the open resonator produced by the cavity between the patch and the ground plane. This resonator is fed by coaxial cable penetrating by its central conductor into the cavity and shortly connected to the patch on its inner side. The connection point is selected for the optimal impedance matching. The input impedance vs. frequency seen by the coaxial feed of a typical single isolated rectangular patch resonator is shown below in FIG. 4. The imaginary part of the RF section input impedance reflects primarily the type of reactive energy stored in the rectangular cavity. For instance, negative (or positive) imaginary part symbolizes capacitive (or inductive) character of the reactive energy.

As can be seen, at very low frequencies the antenna behaves as capacitive element, and this is easy to comprehend observing the patch antenna structure. After all, at frequencies much below its resonance frequency, the patch antenna is an electrically small radiator developing capacitive near E-field confined primarily in the volume between the patch and the ground plane. In the shown in FIG. 4 example, at 1 GHz the antenna is at the point of series resonance, where active and reactive parts of its input impedance are low. According to the accepted practice in the relevant field of the technology, the antenna operates at the next, parallel resonance point (about 1.35 GHz in the FIG. 4). This approach provides the antenna characterized by a high value of active part of its input impedance and may be easier matched to the output impedance of the RF power source. Frequency band around the parallel resonance frequency features sharp variations of reactive part of the antenna input impedance. The input reactance varies from relatively high positive values (inductive area) below the parallel resonance frequency, crosses the zero point at the parallel resonance frequency and then reaches negative values (capacitive area). The frequency at which the positive (inductive) reactance of the Resonators 1 and 3 (FIG. 3) is at the apogee, shown as the point A in FIG. 4, may be a proper point of the system operation in our novel design of the CWPT system.

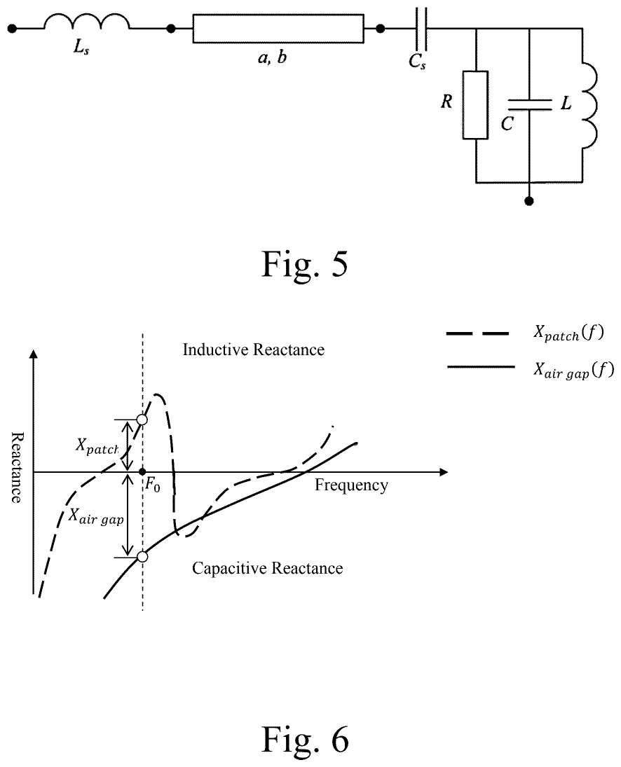

The operation of the present invention at parallel resonance is preferable. FIG. 5 refers to an equivalent lumped-element diagram the TX-RX section of power transmission channel shown in FIG. 1 and FIG. 2.

In general case, resonators 1 and 2 may be not identical, but for simplicity of discussion and without scarifying generality, these resonators will be assumed to be identical. By design, these resonators are tuned to much lower resonance frequency F₁ than the resonator 2. This may be achieved, for example, by means of higher dielectric constant Er of dielectric material employed in the design of patch antennas, and as is dictated by the demand for their miniaturization. Resonators 1 and 3 should exhibit series positive (inductive) reactance jX_{patch} while the air gap contributes the negative (capacitive) reactance jX_{air gap}. At the preferred for the CWPT system operational frequency, the patches design should ensure that the patch antennas are slightly below the frequency of their parallel resonance, and therefore store inductive reactive power, while the volume of air gap between the patches store capacitive reactive power. If this condition is satisfied, then, the frequency responses of the tandem composed by all three resonators may be adjusted in a way that their reactive powers are mutually compensated at the optimal operational frequency. Nevertheless, in some situations an additional matching networks may be required on the TX and RX sides, mostly for accomplishment of the tandem impedance matching to that of energy source (on the TX side) and load (on the RX side), respectively.

At the CWPT system operational frequency F₀, the following condition is satisfied:

$${X}_{air gap} ( {F}_{0} ) + 2 \times {X}_{patch} ( {F}_{0} ) = 0 .$$

The equation is graphically illustrated on the following FIG. 6, where the solid curve represents the series reactance introduced by the air gap (Resonator 2), while the blue curve is the series reactance of two cavities between the patch electrodes and their ground planes.

The novel method of power combining for the purpose of CWPT employs the technique of feeding the same TX or RX electrode by multiple feeds. To great extent this approach resembles the method of multiple feeds known from the prior art in relation to patch antenna technology. The technique of multiple feeding of patch antennas is directed to:
a) generating far-field radiation with circular polarization; and
b) increasing the transfer capacity of data communication channels.

Orthogonal coaxial modes may be characterized by their orbital angular momenta (OAM).

Power combining was demonstrated in prior art also in RF patch antennas technology by feeding the same patch by at least two excitations generating orthogonal electromagnetic modes of the electromagnetic field.

Patch antennas with multiple feeds provide sufficient isolation between the feeds. The isolation may be achieved by combining power of several coherent signals having specific phase distribution ensuring orthogonality of radiated field, both in near and far zones. Traditionally, patch radiators with multiple feeds are employed for generation of far field radiation. The invention disclosed in this patent application has a goal to generate orthogonal near fields in the vicinity of patch-electrode. The orthogonality property of two excited fields, either in far zone or in near zones, has an obvious physical meaning of lack of energy exchange between the modes. Naturally, this should also mean complete decoupling of these two feeds.

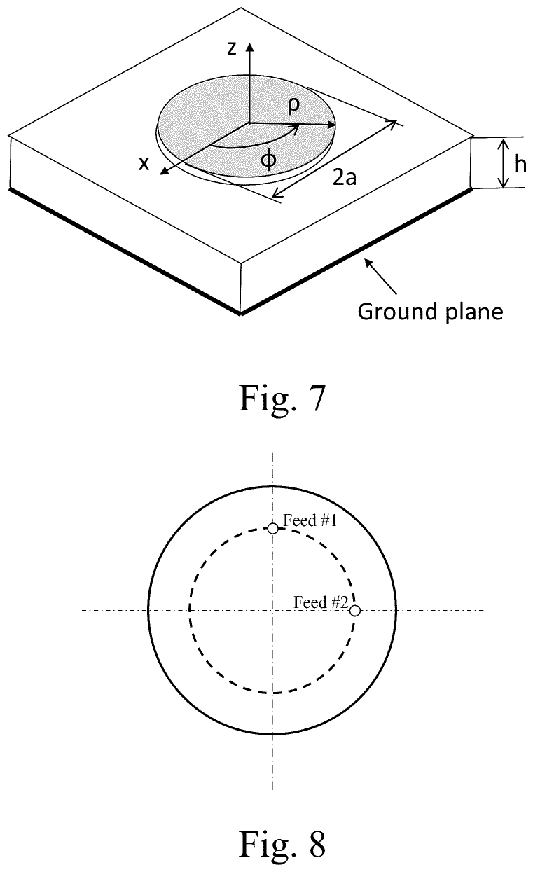

The patch geometry, like circular patch shown in FIG. 7, may possess the property of rotational symmetry, having circular or equilateral polygonal shapes. The most popular in the antenna technique is the use of orthogonal circularly polarized right-hand and left-hand excitations.

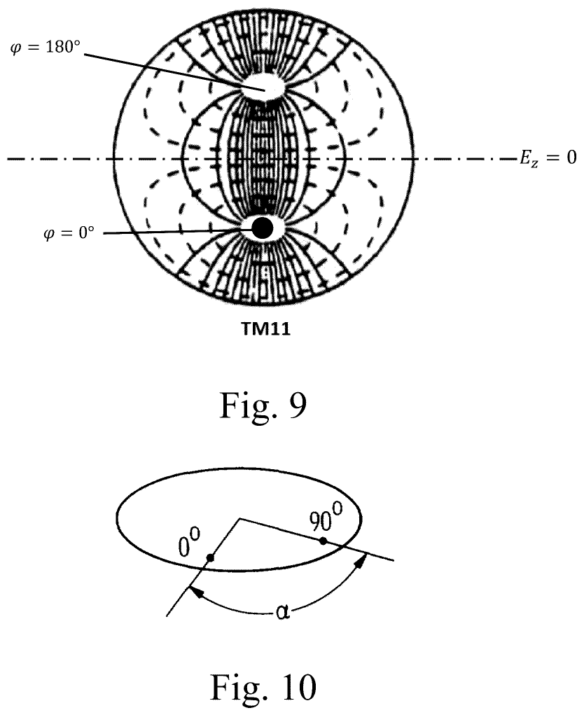

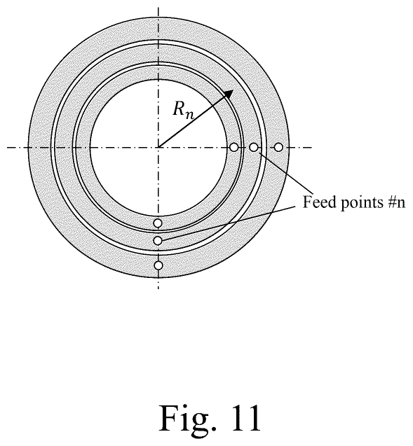

Reference is now made to FIG. 9 presenting an operational mode supported by the cavity between the patch and the ground plane. The cavity supports TM11 mode with electric and magnetic field depending on the azimuthal angle φ as cos(φ). In order to be decoupled, the two feeds should be located in two points of the same circle of radius R but in which phases of the operational cavity mode differing by 90°(cos (90°)=0). In other words, the feed #1 should be in the null point of the cavity mode generated by the feed #2.

The patch electrode providing combination of two orthogonal modes is shown in FIG. 8, was experimentally verified by us for the CWPT and proved its capability to double the transmitted power density. The power combining in the CWPT applications may be implemented in a number of design modalities. Some of these are listed below, but the list does not evolve all additional opportunities presented by this technique:
a) Combining power of two or more coherent signals by feeding a single patch radiator by a number of feeds exciting orthogonal field modes;
b) Combining two coherent signals of different orthogonal polarizations, either linear of circular, whereas the circular polarization may be either right-hand or left-hand;
c) Combining powers of two or more non-coherent carriers of different frequencies coinciding with resonances of orthogonal modes of either of a single or of multiple patch electrode-radiators.

Reference is now made to FIG. 11 presenting a patch electrode are formed by a number of concentrically arranged annular members. The electrodes of concentrically annular geometry may enable are excited simultaneous excitation by a number of generators operating at a variety of operational frequencies. Higher excitation frequency fₙ is suitable for excitation of the ring electrode with proportionally smaller radius Rₙ. The concentrically annular electrodes provide smaller overlap of RF currents paths excited in neighbor rings in comparison with the solid disc. This feature is expedient for higher isolation between different RF power sources feeding the power on the TX side and receiving the power on the RX side.

In addition, the set of circular rings electrodes may be used for adjustment of the CWPT system for operation at an optimal frequency. Our experimental study performed with the CWPT system operating in accordance with the method disclosed by this patent application, revealed strong dependence of the power transmission efficiency on the longitudinal spacing between TX and RX electrodes. The plurality of concentric annular rings possesses a diversity of resonant structures tuned to a variety of resonance frequencies. The CWPT system should select the excitation ring by means of switching of the TX and RX feeders from ring to ring until the optimal ring is selected for a given separation along the longitudinal axis Z between TX and RX electrodes. This switching mechanism may be an employed to resolve the problem of the disclosed in this patent application CWPT system high sensitivity to the parameter of separation width between TX and RX electrodes of the RF power channel.

1. A system for capacitive wireless power transmission comprising:
a. an adjustable RF power source configured for varying an RF frequency thereof;
said adjustable RF power source having an RF power amplifier;
b. a power transmission channel configured for capacitive wireless power transmission further comprising transmitting (TX) and receiving (RX) portions;
said TX and RX portions comprise transmitting and receiving metallic patch electrodes, respectively, facing each other via an air gap;
c. a feedback communication channel configured for providing a feedback signal for matching up an output impedance of the RF power source to impedance instantly presented by the power transmission channel; said feedback communication channel further comprising transmitting and receiving portions FTX and FRX, respectively;
d. a processor configured for varying said RF frequency of said power transmission channel;
wherein each of said TX and RX portions further comprises TX and RX ground planes disposed behind said TX and RX electrodes, respectively; said processor is configured for selecting an RF frequency to be generated by said power source corresponding to minimal power transmission losses by means of compensation of a capacitive reactance formed between said TX and RX electrodes by means of a sum of inductive reactance formed by said TX electrode and TX ground plane, and the reactance formed by said RX electrode and the RX ground plane.

2. The system according to claim 1, wherein said patch electrode is selected from the group consisting of a rectangular patch electrode, a triangular patch electrode, a hexagonal patch electrode, a circular patch electrode, an oval patch electrode, an annular patch electrode, and any combination thereof.

3. The system according to claim 2, wherein said patch TX and RX electrodes has at least one slot, or slit or short to the ground plane.

4. The system according to claim 1, wherein said feedback communication channel is selected from the group consisting of an RF communication channel, an acoustic communication channel, an optical communication channel, and any combination thereof.

5. The system according to claim 4, wherein a carrier of the said feedback communication channel is sufficiently greater than said RF frequency of said RF power source such that the carrier frequency may be modulated by the said frequency of the said power channel.

6. The system according to claim 4, wherein said carrier frequency of said feedback communication channel is modulated in said FTX portion of said communication channel by a signal coherent with an RF power intensity signal received in said RX portion; in said FRX portion of said communication channel, said RF power intensity is demodulated;

7. The system according to claim 6, wherein a demodulated signal is alternatively fed to said processor which controls said RF power source, or to an input port of said RF power amplifier such that said power transmission channel and said communication channel conjointly operate in a self-oscillatory closed loop mode.

8. The system according to claim 1, wherein said power amplifier has an input port; said input port further comprises a frequency selective filter configured for preventing system oscillations at frequencies belonging to a filter stop frequency band; said stop band frequency is adjustable either by said processor or manually.

9. The system according to claim 1, wherein said TX and RX patch electrodes have two or more feed points thereof each connected by coaxial cables to output ports of two or more coherent RF power sources and RX rectifiers, respectively; positions of said feed points correspond minimal return losses of said RF power sources and maximal decoupling of said RF power sources.

10. The system according to claim 1, wherein said TX and RX patch electrodes are disc- or ring-like shaped, said disc- or ring-like shaped patch TX and RX electrodes are excited by first and second coordinated-phase coherent power sources; output powers of said first and second sources each, excite the TM11 mode of cylindrical cavities formed between each electrode and the ground plane in proximity to said disc- or ring-like shaped patch TX and RX electrodes; and said feed points connected to said first and second RF sources are located at a relative coordinated azimuthal orientation.

11. The system according to claim 10, wherein said TX and RX patch electrodes are excited by two or more pairs of said coherent RF power sources; an operation frequency of said power sources within each pair operate does not coincide with operation frequencies of other pairs.

12. The system according to claim 9, wherein said TX and RX patch electrodes are formed by a plurality of concentrically arranged annular members; each annular member of said TX portion is fed by a number of coherent RF sources exciting orthogonal modes of a near electromagnetic field; each annular member of said TX portion is impedance-matched said operation frequency thereof.

13. The system according to claim 12, wherein said operation frequency is selected by maximizing said RF power transmission alternatively by:
a. switching between a plurality of said RF power sources each connected to said annular members of said TX portion in an individual manner, until the maximum power transmission is achieved; and
b. concurrently tuning single RF source to the operational frequency corresponding to a dedicated annular member and connecting its power output port to the said annular member, in a way maximizing the system RF power transmission.
